(19) United States
(12) Patent Application Publication
(10) Pub. No.: US 2015/0127320 A1
(43) Pub. Date: May 7, 2015

(54) METHOD AND APPARATUS FOR TRANSLATION

(71) Applicant: Samsung Electronics Co., Ltd., Suwon-si (KR)

(72) Inventors: Eun-Jung SEO, Gumi-si (KR); Gyu-Cheol CHOI, Gumi-si (KR)

(21) Appl. No.: 14/531,201

(22) Filed: Nov. 3, 2014

(30) Foreign Application Priority Data
Nov. 1, 2013 (KR) 10-2013-0132238

(51) Int. Cl. G06F 17/28; G06F 17/24

(52) U.S. Cl. CPC G06F 17/28; G06F 17/24
USPC 704/2

(57) ABSTRACT

A method and an apparatus for processing a translation process which can minimize a change of a position of a text and an object and a change of a layout, where are included in original text are provided. A translation method includes identifying original text and translated text in which the original text is translated, and replacing at least one first translation object included in the translated text with a second translation object by comparing a length of the original text and a length of the translated text.

### CROSS-REFERENCE TO RELATED APPLICATION(S)

This application claims the benefit under 35 U.S.C. §119(a) of a Korean patent application filed on Nov. 1, 2013 in the Korean Intellectual Property Office and assigned Serial number 10-2013-0132238, the entire disclosure of which is hereby incorporated by reference.

### TECHNICAL FIELD

The present disclosure relates to a translation processing technology of an electronic device.

### BACKGROUND

Currently, various services and additional functions provided in an electronic device have gradually increased. In order to increase an effective value of the electronic device and meet various demands of users, various applications executable by the electronic device have been developed.

The electronic device may store and execute basic applications developed by a manufacturer of a corresponding device and originally installed in the corresponding device. Additional applications may be downloaded from a website selling applications through the Internet, and the like. The additional applications may be developed by general developers and registered on websites that sell the applications. Accordingly, a person who develops an application may freely sell the application to a user of the electronic device via the websites on which such applications are sold. As a result, the electronic device is currently provided with tens of thousands to hundreds of thousands of applications free of charge or at a cost which may vary among different products.

An application for processing a translation process is provided among the hundreds of thousands of applications. The translation processing application is provided by translating texts included in a document and/or the web page into another language.

Accordingly, an apparatus and method for the translated text or the web page may include an arrangement or length which is different with the original text by a difference between a length of a text included in the original text and a length or arrangement of the translated text is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for the translated text or the web page may include an arrangement or length which is different with the original text by a difference between a length of a text included in the original text and a length or arrangement of the translated text. Especially, when objects such as an image, a diagram, a graph, or the like are included in the document or the web page, the arrangement of the translated text is configured to be different from the original text by an object variously distributed in the document or the web page.

By considering the point described above, the present disclosure provides a method and an apparatus for processing a translation process which may minimize a change of a position of a text and an object and a change of a layout, where are included in original text.

In accordance with an aspect of the present disclosure a translation method is provided. The translation method includes identifying original text and translated text in which the original text is translated, and replacing at least one first translation object included in the translated text with a second translation object by comparing a length of the original text and a length of the translated text.

In accordance with another aspect of the present disclosure, an apparatus for providing a translation process is provided. The apparatus includes a memory unit that stores a translation program and data generated while processing the translation program, and at least one controller, wherein the translation process program is configured to be executed by the controller, and includes a command that identifies original text and translated text in which the original text is translated and replaces at least one first translation object included in the translated text with a second translation object by comparing a length of the original text and a length of the translated text.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating an order of a translation method according to an embodiment of the present disclosure;

FIG. 2A is a flowchart illustrating an example of a process of replacing a first translation object with a second translation object included in a translation method according to an embodiment of the present disclosure;

FIG. 2B is a flowchart illustrating an example of a detailed configuration of a process of replacing a first translation object with a second translation object included in the translation method according to an embodiment of the present disclosure;

FIG. 3 is a flowchart illustrating another example of a process of replacing a first translation object with a second translation object included in the translation method according to an embodiment of the present disclosure;

FIGS. 4A, 4B, 4C, and 4D illustrate examples of an apparatus applying a translation method according to various embodiments of the present disclosure; and

FIG. 5 is a block diagram of an apparatus applying a translation method according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

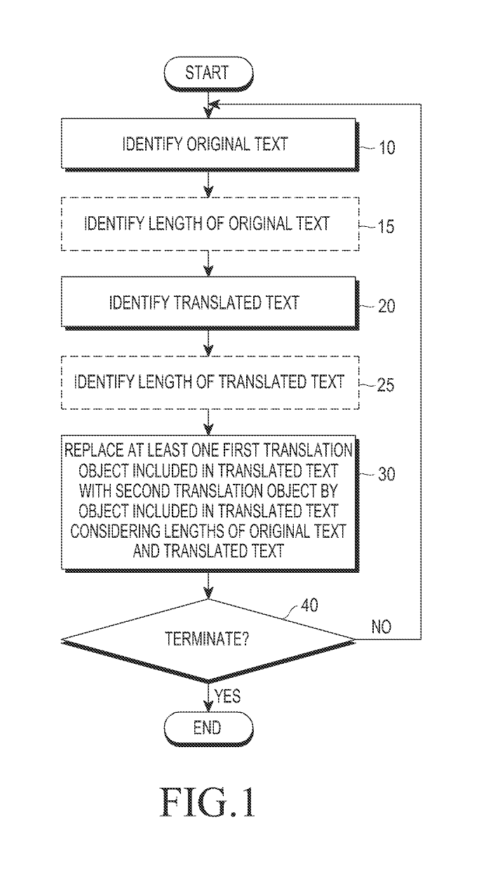

FIG. 1 is a flowchart illustrating an order of a translation method according to an embodiment of the present disclosure.

Referring to FIG. 1, a translation method according to an embodiment of the present disclosure includes operation 10 of identifying original text, operation 20 of identifying translated text and operation 30 of replacing at least one first translation object included in the translated text with a second translation object by comparing lengths of the original text and the translated text.

The translation method according to an embodiment of the present disclosure may provide an operation in which a translation processing application included in the electronic device is operated.

For example, an icon corresponding to the translation processing application may be selected, or an operation of the translation processing application may be executed according to receiving an input of a command. As described above, when the operation of the translation processing application has provided, an original input window receiving original text (e.g., text) to be translated may be provided and operation 10 may be proceed by receiving an input of the original text (e.g., text) in the original input window using an input device included in the electronic device.

For another example, the translation processing application may be configured to provide a submenu allowing a text included in a memo pad, a document, a web page, or the like to be selected. That is, in a state in which the memo pad, the document, the web page, or the like is provided through an electronic device, a menu, a “copy” menu, a “cut out” menu, a “translation” menu, or the like may be provided allowing a text included in the memo pad, the document, the web page, or the like to be selected by a user. The “translation” menu is selected among the menus so that the selected text may be input as original text to be translated.

Although operation 10 of receiving an input of the original text corresponding to an operation of the translation processing application is illustrated in an embodiment of the present disclosure, the present disclosure is not limited thereto and any process of identifying the original text may be applied as long as an input of the original text to be translated may be received. For example, receiving an input of the original text to be translated using a technology such as an Optical Character Recognition (OCR), a character input using an image analysis, a character input through voice recognition, or the like, or the like may be applied by being variously changed by a person having ordinary skill in a technical filed of the present disclosure.

Operation 20 includes a process of processing a translation with respect to the original text. For example, a kind of language with respect to the original text (e.g., the first language) is identified and a kind of language with respect to the translated text (e.g., the second language) is identified. According to a translation algorithm, original text of the first language is converted into translated text of the second language and the translated text is identified.

Units of the original text and the translated text may be variously changed as a word unit, a sentence unit, a paragraph unit, and the like.

The original text and the translated text may be represented such that lengths of the original text and translated text are different from each other due to linguistic characteristics of the respective language. There may be a case in which the lengths of the original text and the translated text are required to be similarly adjusted as much as possible. Operation 30 performs an operation of adjusting the lengths of the original text and the translated text. To this end, the lengths of the original text and the translated text are required to be identified. The lengths of the original text and the translated text may be identified in operation 30 and may be respectively identified in operation 10 and operation 20, after the translation process is completed. In response, operation 10 according to an embodiment of the present disclosure may further include operation 15 of identifying the length of the original text and operation 20 may further include a process of identifying the length of the translated text.

Furthermore, operation 30 determines whether the length of the translated text is included within a configured standard length based on the original text. When the length of the translated text is greater than the standard length, an operation of changing the length of the translated text is processed in order to reduce a difference between the length of the original text and the length of the translated text. The operation of changing the length of the translated text may be an operation of changing at least one first translation object included in the translated text into other alternative second translation object. For example, the first translation object and the second translation object may be the word unit. The second object may be an alternative word having a meaning which is identical to the first translation word.

Moreover, the standard length may include the length of the original text.

Even though the first translation object included in the original text is changed into the second translation object, an arrangement of a word, a character, or the like included in the translated text may be changed differently to an arrangement included in the original text. In operation 30, it is preferable to change the first translation object into the second translation object so as to maintain the arrangement of the word or the character included in the original text and translated text without disruption. Therefore, the standard length may include a length of a range which be maintained without disrupting the arrangement of the word, the character, or the like included in the original text. For example, the standard length may include a maximum length or a minimum length which may be maintained without disrupting the arrangement of the word, the character, or the like included in the original text. In addition, the standard length may include a maximum length acceptable in a line unit of the original text and a minimum length acceptable in a line unit of the original text.

When the length of the translation text is greater than the standard length, in order to reduce a difference between the lengths of the original text and the transmitted text, the second translation object which has a meaning which is identical to the first translation object is included and an operation of identifying a word having a size which may reduce a difference between the lengths of the original text and the transmitted text may be included. For example, the first translation object is a full name of the word and the second translation object may include an abbreviation. On the contrary, the first object translation object is an abbreviation of the word and the second translation object may include a full name.

For another example, the first translation object and the second translation object may be a phrase unit or a sentence unit which combines a plurality of words.

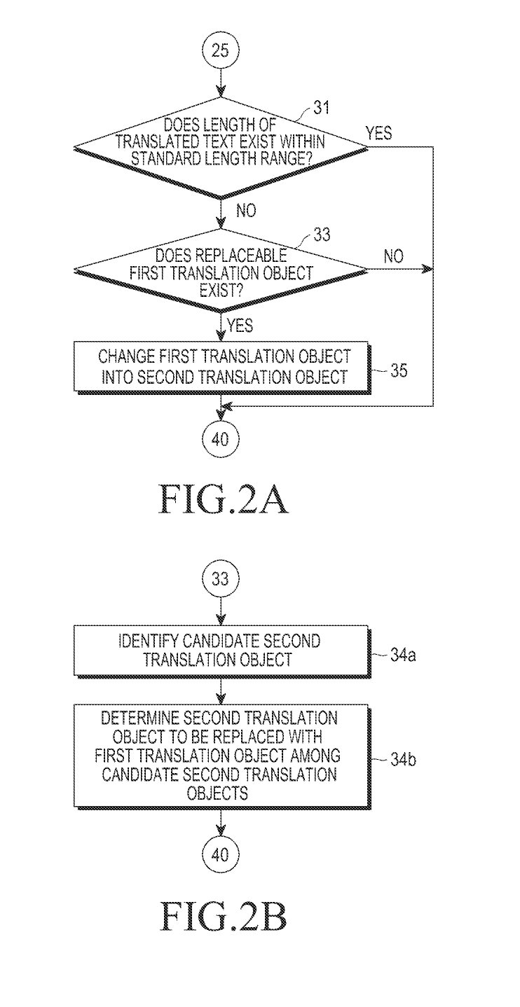

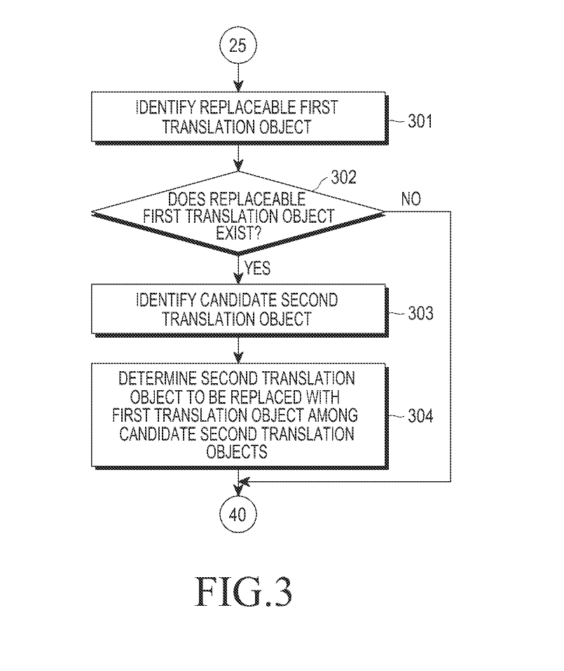

FIG. 2A is a flowchart illustrating an example of a process of replacing a first translation object with a second translation object included in the translation method according to an embodiment of the present disclosure.

Referring to FIG. 2A, in operation 31, it is determined whether the length of the translated text is included in the standard length range. When the length of the translated text does not exceed the standard length (i.e., the length of the translated text is identical to the length of the original text (32—No)), the first translated object is not required to be replaced with the second translation object so that operation 40 which is a next operation is processed. Whereas, when the length of the translated text is greater than the standard length (32—Yes), the first translation object is required to be replaced with the second translation object so that an operation (operation 33) for replacing the first translation object with the second translation object is processed.

In operation 33, it is determined whether a replaceable first translation object exists. For example, it is determined whether the second translation object having a meaning which is similar or identical to at least one first translation object included in the translated text exists. Operation 40 is processed when the replaceable first translation object does not exist (33—No) and operation 34 is processed when the replaceable first translation object exists (33—Yes).

In operation 34, the second translation object having a meaning which is similar or identical to the first translation object is determined and the first translation object is changed into the second translation object.

FIG. 2B is a flowchart illustrating an example of a detailed configuration of operation 34 in FIG. 2A according to an embodiment of the present disclosure.

Referring to FIG. 2B, first, in operation 34A, at least one word (or, a phase, a sentence, or the like) having a meaning which is similar or identical to the first translation object is identified as a candidate second translation object.

In operation 34B, a second translation object among one or more the candidate second translation objects to replace the first translation object is determined. For example, a candidate second translation object which has a highest similarity in comparison with the meaning of the first translation object may be determined as the second translation object through an operation of identifying a similarity between a meaning of the one or more candidate second translation objects and a meaning of the first translation object, or the like. For another example, a word (or, a phase, a sentence, or the like) having a most suitable length among the candidate second translation objects may be selected and determined as the second translation object. For another example, the most suitable candidate second translation object may be determined as the second translation object by reflecting both a similarity and a length factor from one or more candidate second translation objects.

FIG. 3 is a flowchart illustrating another example of a process of replacing a first translation object with a second translation object included in the translation method according to an embodiment of the present disclosure.

Referring to FIG. 3, in operation 301, when a first translation object which is replaceable without a difference between the length of the original text and the length of the translated text exists, the first translation object may be changed into the second translation object. For example, it is determined whether the second translation object having a meaning which is similar or identical to at least one first translation object included in the translated text exists. Operation 40 is processed when the replaceable first translation object does not exist (302—No) and operation 303 is processed when the replaceable first translation object exists (302—Yes).

In operation 303, at least one word (or, a phase, a sentence, or the like) having a meaning which is similar or identical to the first translation object is identified as a candidate second translation object.

In operation 304, a second translation object to be replaced with the first translation object among one or more the candidate second translation objects is determined. For example, a candidate second translation object which has a highest similarity in comparison with the meaning of the first translation object may be determined as the second translation object through an operation of identifying a similarity between a meaning of the one or more candidate second translation objects and a meaning of the first translation object, or the like.

Even though it is illustrated that the second translation object is determined based on the similarity with the first translation object in various embodiments of the present disclosure, the preset disclosure is not limited thereto. For example, when the second translation object is determined, a candidate second translation object which is most similar to the meaning of the original text among the one or more candidate second translation objects may be determined as a second translation object.

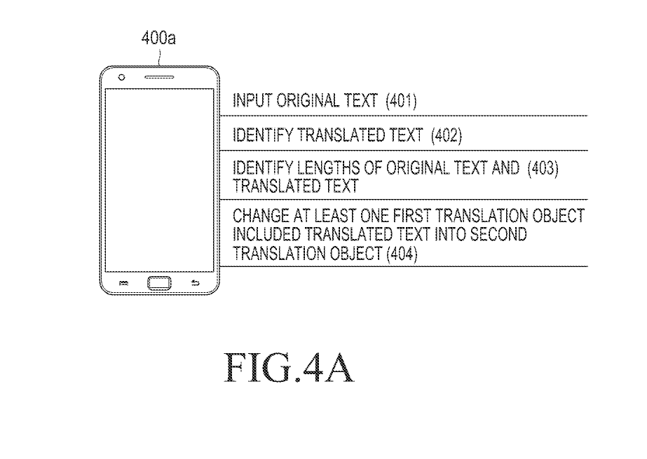

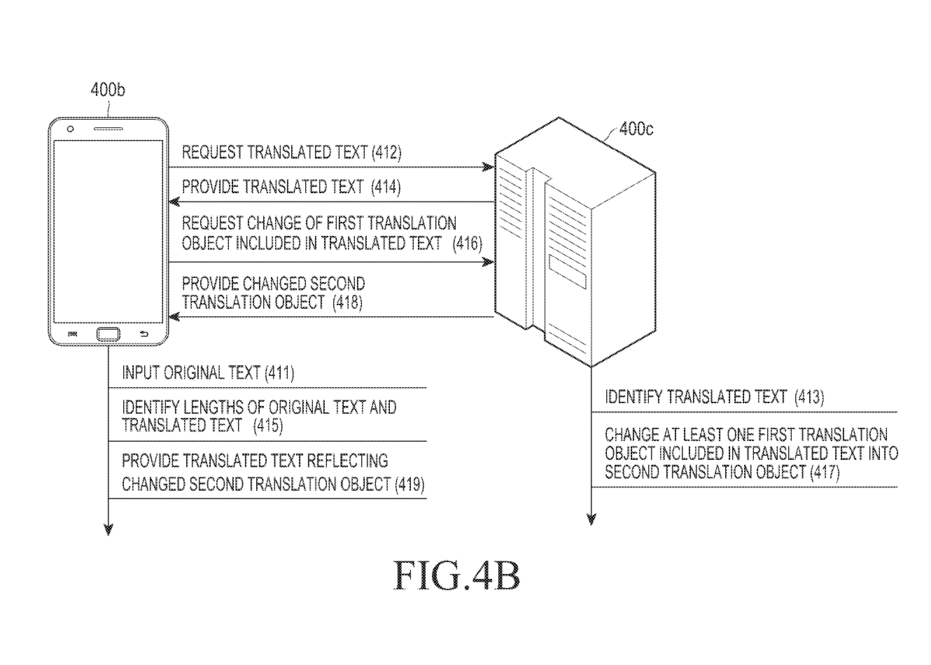

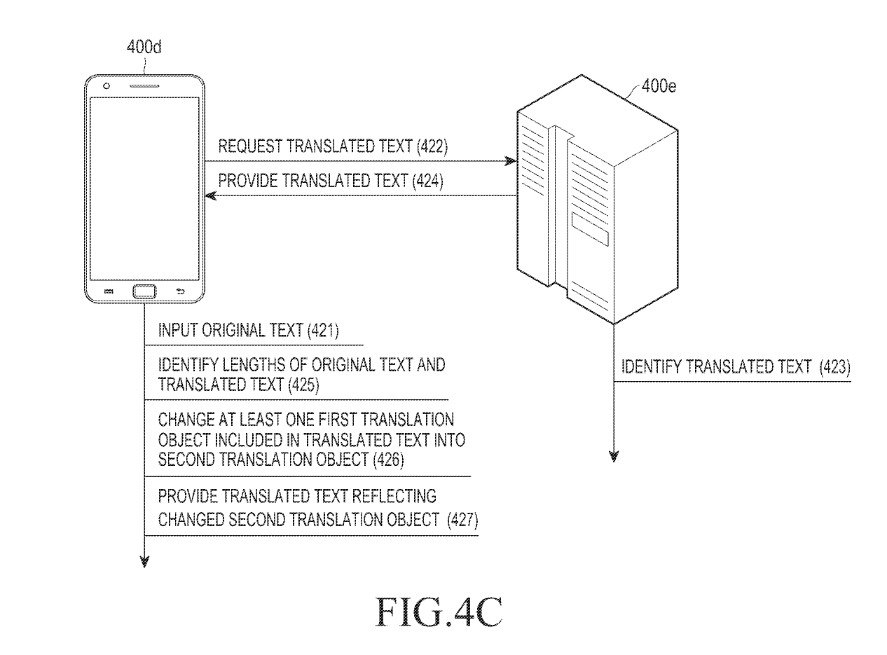

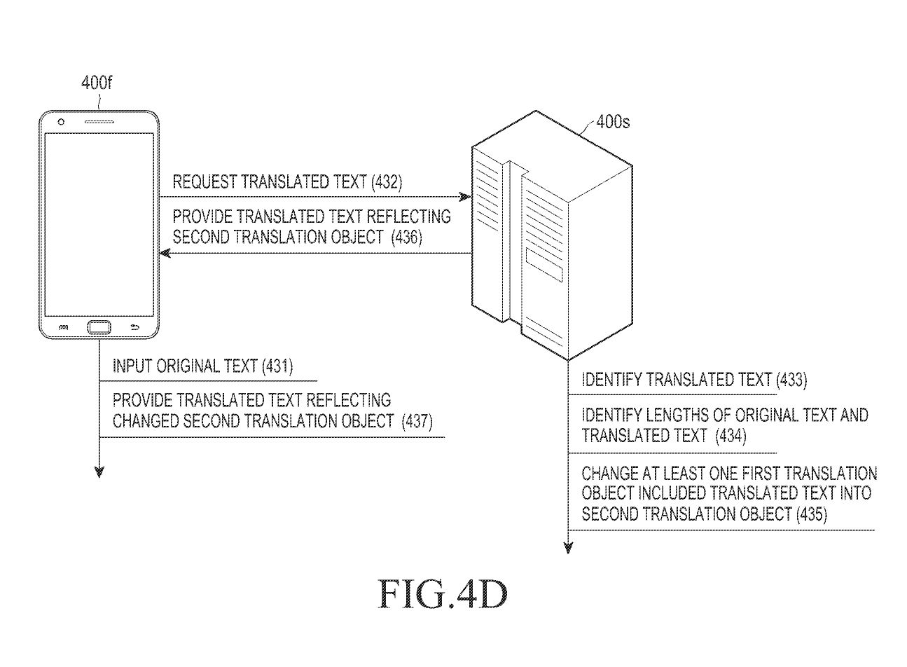

FIGS. 4A to 4D illustrate examples of an apparatus which applies a translation method according to various embodiments of the present disclosure.

First, FIG. 4A illustrates a case in which a translation method according to various embodiments of the present disclosure is applied to a terminal device.

Referring to FIG. 4A, a terminal device 400a may be configured so as to process all translation methods according to various embodiments of the present disclosure as described above.

For an example, the terminal device 400a may execute a translation process application which is installed therein and an environment which may receive an input of original text to be translated as the translation process application is operated. For another example, the terminal device 400a may provide an original text input window which receives an input of the original text (e.g., a text) to be translated and an input of the original text (e.g., a text) may be received in the original text input window by using an input device included in the terminal device 400a (e.g., a key pad, a soft keypad, a character input engine using an image analysis, a character input engine through a voice recognition, or the like).

For another example, the terminal device 400a may operate a translation process application installed therein and may be configured so as to provide a submenu allowing a text included in a memo pad, a document, a web page, or the like to be selected, as the translation process application is operated. That is, in a state in which the memo pad, the document, the web page, or the like is provided through an electronic device, the terminal device 400a provides a menu, a “copy” menu, a “cut out” menu, a “translation” menu, or the like such that a text included in the memo pad, the document, the web page, or the like is selected. The “translation” menu is selected among the menus so that the selected text may be input as original text to be translated.

Although operation 401 of receiving an input of the original text corresponding to an operation of the translation processing application is illustrated in an embodiment of the present disclosure, the present disclosure is not limited thereto and any process of identifying the original text may be applied as long as an input of the original text to be translated may be received.

The terminal device 400a processes as indicated by reference number 402 an operation of identifying translated original text. For example, a kind of language with respect to the original text (e.g., a first language) and a kind of language with respect to the translated text (e.g., a second language) are identified and the translated text is identified through an operation of changing original text of the first language into translated text of the second language according to a translation algorithm. The first language may be selected by an input of the user or be actively detected by analyzing characteristics of the language.

Units of the original text and the translated text may be variously changed to a word unit, a sentence unit, a paragraph unit, and the like.

The original text and the translated text may be represented such that lengths of the original text and translated text are different each other due to linguistic characteristics. There may be a case in which the lengths of the original text and the translated text are required to be similarly adjusted as much as possible. Therefore, the terminal device 400a may perform an operation for adjusting lengths of the original text and the translated text. To this end, the lengths of the original text and the translated text are required to be identified. In operation 403, the lengths of the original text and the translated text are identified after the translation process is completed.

Even though it is illustrated that the lengths of the original text and the translated text are identified in operation 403 after the translation process is completed, the present disclosure is not limited thereto. For instance, the lengths of the original text and the translated text may be respectively identified in operation 401 and operation 402.

The terminal device 400a compares the length of the original text with the length of the translated text and identifies a difference between the length of the original text and the length of the translated text. When the difference between the length of the original text and the length of the translated text is large, an operation of changing the length of the translated text is processed as indicated by reference number 404 in order to reduce a difference between the length of the original text and the length of translated text. The operation of changing the length of the translated text may be an operation of changing at least one first translation object included in the translated text into an alternative second translation object. For example, the first translation object and the second translation object may be the word unit. The second object may be an alternative word having a meaning which is identical to the first translation word. Moreover, when the length of the translated text is relatively long in comparison with the length of the original text, the second translation object should include a relatively smaller number of characters than the first translated text. When the length of the translated text is relatively short in comparison with the length of the original text, the second translation object should include a relatively greater number of characters than the first translated text. Considering this, operation 30 may be configured so that the second translation object has a meaning which is identical to the first translation object and include an operation of identifying a word having a size which may reduce a difference between the length of the original text and the translated text. For example, the first translation object may be a full name of the word and the second translation object may include an abbreviation. On the contrary, the first object translation object may be an abbreviation of the word and the second translation object may include a full name.

For another example, the first translation object and the second translation object may be a phrase unit or a sentence unit which combine a plurality of words.

Furthermore, in an embodiment of the present disclosure, it is illustrated that the first translation object and the second translation object may be a word unit, a phase unit, a sentence unit, but the preset disclosure is not limited thereto. The preset disclosure requires only that the first translation object may be replaced with the second translation object having a meaning which is identical or similar to the first translation object and a length which may reduce the difference between the length of the original text and the length of the second translation.

FIG. 4B illustrates that a translation method according to various embodiments of the preset disclosure is applied to a first system.

Referring to FIG. 4B, the first system to which the translation method according to various embodiments of the present disclosure is applied includes a terminal device 400b and a translation server device 400c.

The terminal device 400b and the translation server device 400c may be configured so as to properly divide and process the translation method according to various embodiments of the present disclosure as needed.

For example, the terminal device 400b receives an input of original text, identifies lengths of the original text and translated text and processes an operation of requesting a changing of the first translation object and the second translation object. The translation server device 400c may be included so as to process an operation of processing translation requested from the terminal device 400b and processing the changing of the first translation object and the second translation object.

First, in operation 411, the terminal device 400b may execute a translation process application and provide an environment which may receive an input of original text to be translated as the translation process application is operated. For example, the terminal device 400b may provide an original text input window which receives, as indicated by reference number 411, an input of the original text (e.g., a text) to be translated and an input of the original text (e.g., a text) may be received in the original text input window by using an input device included in the electronic device (e.g., a key pad), a soft keypad, a character input engine using an image analysis, a character input engine through a voice recognition, or the like.

For another example, the terminal device 400b may operate a translation process application installed therein and be configured so as to provide a submenu allowing a text included in a memo pad, a document, a web page, or the like to be selected, as the translation process application is operated. That is, in a state in which the memo pad, the document, the web page, or the like is provided through an electronic device, the terminal device 400b provides a menu, a “copy” menu, a “cut out” menu, a “translation” menu, or the like allowing a text included in the memo pad, the document, the web page, or the like to be selected. The “translation” menu among the menus is selected so that the selected text may be input as original text to be translated.

Although operation 10 in FIG. 1 receiving an input of the original text corresponding to an operation of the translation processing application is illustrated in an embodiment of the present disclosure, the present disclosure is not limited thereto and operation 10 identifying the original text may be applied as long as an input of the original text to be translated may be received.

The terminal device 400b processes an operation of requesting a translation with respect to the original text. The first system according to an embodiment of the present disclosure is configured so as to allow the server device 400c to process a translation. Therefore, when an input of a request for the translation with respect to the original text has been received, that is, an input of an event corresponding to a translation request menu (or a translation request icon, or the like) has been received in a state in which the original input window is provided or an input of an event corresponding to “translation” menu has been received in a state in which a text included in the memo pad, the document, the web page, or the like is selected, the terminal device 400b processes, in operation 412, an operation of requesting the translation for the original text. Further, in operation 412, the terminal device 400b may identify a kind of language of the original text (e.g., a first language) and a kind of language of the translated text (e.g., a second language) and provide the identified first language and second language to the translation server device 400c.

The first language may be selected by an input of the user. Therefore, when the environment is configured so as to allow the first language to be selected by an input of the user, the terminal device 400b may provide the first language to the translation server device 400c in operation 412. For another example, the first language may be actively detected by analyzing characteristics of the language. The detection of the first language may be processed by the terminal device 400b and the translation server device 400c. When the terminal device 400b has detected the first language, the terminal device 400b may provide the first language to the translation server device 400c in operation 412 or the translation server device 400c may detect the first language without being provided with the first language.

The translation server device 400c receives a request for the identifying translated text, in operation 413, an operation which corresponds thereto (i.e., an operation of processing the translation). For example, a kind of language with respect to the original text (e.g., a first language) and a kind of language with respect to the translated text (e.g., a second language) are identified and original text of the first language is changed into translated text of the second language according to a translation algorithm. Further, the translation server device 400c provides the translated text to the terminal device 400b in operation 414.

The original text and the translated text may be represented such that lengths of the original text and the translated text are different from each other due to linguistic characteristics. There may be a case in which the lengths of the original text and the translated text are required to be similarly adjusted as much as possible. Therefore, the terminal device 400b may perform an operation for adjusting lengths of the original text and the translated text. To this end, the lengths of the original text and the translated text are required to be identified. The terminal device 400b identifies the lengths of the original text and the translated text in operation 415.

Even though it is illustrated that the lengths of the original text and the translated text are identified in operation 415 after the translation process is completed, the present disclosure is not limited thereto. For instance, the lengths of the original text and translated text may be respectively identified in operation 411 and operation 413.

The terminal device 400b compares the length of the original text with the length of the translated text and identifies a difference between the length of the original text and the length of the translated text. When the difference between the length of the original text and the length of the translated text is great, an operation of reducing the length of the translated text is processed in order to reduce a difference between the length of the original text and the length of translated text. The operation of reducing the length of the translated text may be an operation of changing at least one first translation object included in the translated text into an alternative second translation object. For instance, the terminal device 400b requests, in operation 416, at least one first translation object included in the translated text to be changed into one other replaceable second translation object, to the translation server device 400c. In response, the translation server device 400c changes, in operation 417, the at least one first translation object included in the translated text into the other replaceable second translation object.

For example, the first translation object and the second translation object may be a word unit. The second translation object may be an alternative word having a meaning which is identical to the first translation word. Moreover, when the length of the translated text is relatively long in comparison with the length of the original text, the second translation object should include a relatively smaller number of characters than the first translated text. When the length of the translated text is relatively short in comparison with the length of the original text, the second translation object should include a relatively larger number of characters than the first translated text. Considering this, operation 417 may be configured so that the second translation object has a meaning which is identical to the first translation object and include an operation of identifying a word having a size which may reduce a difference between the length of the original text and the translated text. For example, the first translation object may be a full name of the word and the second translation object may include an abbreviation. On the contrary, the first object translation object may be an abbreviation of the word and the second translation object may include a full name.

For another example, the first translation object and the second translation object may be a phrase unit or a sentence unit which combine a plurality of words.

Furthermore, in an embodiment of the present disclosure, it is illustrated that the first translation object and the second translation object may be a word unit, a phase unit, a sentence unit, but the preset disclosure is not limited thereto. The preset disclosure requires only that the first translation object may be replaced with the second translation object having a meaning which is identical or similar to the first translation object and a length which may reduce the difference between the length of the original text and the length of the second translation.

As described above, after the at least one first translation object included in the translated text is changed into the other replaceable second translation object, the translation server device 400c provides, in operation 418, the changed second translation object to the terminal device 400b, and the terminal device 400b provides, in operation 419, translated text to which the second translation object is reflected.

FIG. 4C illustrates that a translation method according to various embodiments of the preset disclosure is applied to a second system.

Referring to FIG. 4C, the second system to which the translation method according to various embodiments of the present disclosure is applied includes a terminal device 400d and a translation server device 400e.

The terminal device 400d and the translation server device 400e may be configured so as to properly divide and process the translation method according to various embodiments of the present disclosure as needed.

For example, the terminal device 400d receives an input of original text, identifies lengths of the original text and the translated text and processes an operation of changing a first translation object and a second translation object. The translation server device 400e may be configured to process a translation which is requested from the terminal device 400e.

First, the terminal device 400d may execute a translation process application and provide an environment which may receive an input of original text to be translated as the translation process application is executed. For example, the terminal device 400d may provide an original text input window which receives, in operation 421, an input of the original text (e.g., a text) to be translated and an input of the original text (e.g., a text) may be received in the original text input window by using an input device included in the electronic device (e.g., a key pad, a soft keypad, a character input engine using an image analysis, a character input engine through a voice recognition, or the like).

For another example, the terminal device 400d may execute a translation process application installed therein and be configured so as to provide a submenu allowing a text included in a memo pad, a document, a web page, or the like is selected, as the translation process application to be operated. That is, in a state in which the memo pad, the document, the web page, or the like is provided through an electronic device, the terminal device 400b provides a menu, a “copy” menu, a “cut out” menu, a “translation” menu, or the like such that a text included in the memo pad, the document, the web page, or the like may be selected. The “translation” menu among the menus may be selected so that the selected text may be input as original text to be translated.

Although operation 421 of receiving an input of the original text corresponding to an operation of the translation processing application is illustrated in an embodiment of the present disclosure, the present disclosure is not limited thereto and operation 421 identifying the original text requires only that an input of the original text to be translated may be received.

The terminal device 400d processes, in operation 422, an operation of requesting a translation with respect to the original text. The first system according to an embodiment of the present disclosure is configured so as to allow the translation server device 400e to process a translation. Therefore, when an input of a request for the translation with respect to the original text has been received, that is, an input of an event corresponding to a translation request menu (or a translation request icon, or the like) has been received in a state in which the original input window is provided or an input of an event corresponding to “translation” menu has been received in a state in which a text included in the memo pad, the document, the web page, or the like is selected, the terminal device 400d processes, in operation 422, an operation of requesting the translation with respect to the original text to the translation server device 400e. Further, in operation 422, the terminal device 400d may identify a kind of language of the original text (e.g., a first language) and a kind of language of the translated text (e.g., a second language) and provide the identified first language and second language to the translation server device 400e.

The first language may be selected by an input of the user. Therefore, when the environment is configured to allow the first language to be selected by an input of the user, the terminal device 400d may provide the first language to the translation server device 400e in operation 422. For another example, the first language may be actively detected by analyzing characteristics of the language. The detection of the first language may be processed by the terminal device 400d and the translation server device 400e. When the terminal device 400d has detected the first language, the terminal device 400d may provide the first language to the translation server device 400e in operation 412 to the translation server device 400e and the translation server device 400e may detect the first language without being provided with the first language from the terminal device 400d.

The translation server device 400e receives a request for the translation and processes, in operation 423, an operation which corresponds thereto (i.e., an operation of processing the translation). For example, a kind of language with respect to the original text (e.g., a first language) and a kind of language with respect to the translated text (e.g., a second language) are identified and original text of the first language is changed into translated text of the second language according to a translation algorithm. Further, the translation server device 400e provides, in operation 424, the translated text to the terminal device 400d.

The original text and the translated text may be represented such that lengths of the original text and the translated text are different from each other due to linguistic characteristics. There may be a case in which the lengths of the original text and the translated text are required to be similarly adjusted as much as possible. Therefore, the terminal device 400d may perform an operation for adjusting lengths of the original text and the translated text. To this end, the lengths of the original text and the translated text are required to be identified. The terminal device 400d identifies the lengths of the original text and the translated text in operation 425.

Even though it is illustrated that the lengths of the original text and the translated text are identified in operation 425 after the translation process is completed, the present disclosure is not limited thereto. For instance, the lengths of the original text and the translated text may be respectively identified in operations 421 and 423.

The terminal device 400d compares the length of the original text with the length of the translated text and identifies a difference between the length of the original text and the length of the translated text. When the difference between the length of the original text and the length of the translated text is large, an operation of reducing the length of the translated text is processed in order to reduce a difference between the length of the original text and the length of translated text. The operation of reducing the length of the translated text may be an operation of changing at least one first translation object included in the translated text into an alternative second translation object. For example, the translation server device 400d changes, as indicated by reference number 426, at least one first translation object included in the translated text into a replaceable second translation object.

For example, the first translation object and the second translation object may be a word unit. The second object may be an alternative word having a meaning which is identical to the first translation word. Moreover, when the length of the translated text is relatively long in comparison with the length of the original text, the second translation object should include a relatively smaller number of characters than the first translated text. When the length of the translated text is relatively short in comparison with the length of the original text, the second translation object should include a relatively larger number of characters than the first translated text. Considering this, operation 426 may be configured such that the second translation object has a meaning which is identical to the first translation object and include an operation of identifying a word having a size which may reduce a difference between the length of the original text and the transmitted text. For example, the first translation object is a full name of the word and the second translation object may include an abbreviation. On the contrary, the first object translation object may be an abbreviation of the word and the second translation object may include a full name.

For another example, the first translation object and the second translation object may be a phrase unit or a sentence unit which combine a plurality of words.

Furthermore, in an embodiment of the present disclosure, it is illustrated that the first translation object and the second translation object may be a word unit, a phase unit, a sentence unit, but the preset disclosure is not limited thereto. The preset disclosure requires only that the first translation object may be replaced with the second translation object having a meaning which is identical or similar to the first translation object and a length which may reduce the difference between the length of the original text and the length of the second translation.

As described above, after the at least one first translation object included in the translated text is changed into other replaceable second translation object, the terminal device 400d provides, in operation 427, translated text to which the second translated object is reflected.

Meanwhile, FIG. 4D illustrates that a translation method according to various embodiments of the preset disclosure is applied to a third system.

Referring to FIG. 4D, the third system to which the translation method according to various embodiments of the present disclosure is applied includes a terminal device 400f and a translation server device 400g.

The terminal device 400f and the translation server device 400g may be configured so as to properly divide and process the translation method according to various embodiments of the present disclosure as needed.

For example, the terminal device 400f receives an input of original text and requests a translation to the translation server device 400g. The translation server device 400g may be configured so as to process the translation requested from the terminal device 400f, identify the lengths of the original text and the translated text and process an operation of changing the first translation object and the second translation object.

First, the terminal device 400f may execute a translation process application and provide an environment which may receive an input of original text to be translated as the translation process application is executed. For example, the terminal device 400f may provide an original text input window which receives, in operation 431, an input of the original text (e.g., a text) to be translated and an input of the original text (e.g., a text) may be received in the original text input window by using an input device included in the electronic device (e.g., a key pad, a soft keypad, a character input engine using an image analysis, a character input engine through a voice recognition, or the like).

For another example, the terminal device 400f may execute a translation process application installed therein and be configured so as to provide a submenu allowing a text included in a memo pad, a document, a web page, or the like to be selected, as the translation process application is executed. That is, in a state in which the memo pad, the document, the web page, or the like is provided through an electronic device, the terminal device 400f provides a menu, a “copy” menu, a “cut out” menu, a “translation” menu, or the like so that a text included in the memo pad, the document, the web page, or the like may be selected. The “translation” menu among the menus may be selected so that the selected text may be input as original text to be translated.

Although operation 431 of receiving an input of the original text corresponding to an operation of the translation processing application is illustrated in an embodiment of the present disclosure, the present disclosure is not limited thereto and operation 431 of identifying the original text may be applied as long as an input of the original text to be translated may be received.

The terminal device 400f processes, in operation 432, an operation of requesting a translation with respect to the original text. The third system according to an embodiment of the present disclosure is configured so as to allow the server device 400g to process a translation. Therefore, when an input of a request for the translation with respect to the original text has been received, that is, an input of an event corresponding to a translation request menu (or a translation request icon, or the like) has been received in a state in which the original input window is provided or an input of an event corresponding to “translation” menu has been received in a state in which a text included in the memo pad, the document, the web page, or the like is selected, the terminal device 400f processes, in operation 432, an operation of requesting the translation with respect to the original text to the translation server device 400g. Further, in operation 432, the terminal device 400f may identify a kind of language of the original text (e.g., a first language) and a kind of language of the translated text (e.g., a second language) and provide the identified first language and second language to the translation server device 400g.

The first language may be selected by an input of the user. Therefore, when the environment is configured so as to allow the first language to be selected by an input of the user, the terminal device 400f may provide the first language to the translation server device 400g in operation 432. For another example, the first language may be actively detected by analyzing characteristics of the language. The detection of the first language may be processed by the terminal device 400f and the translation server device 400g. When the terminal device 400f has detected the first language, the terminal device 400f may provide the first language to the translation server device 400g in operation 432 and the translation server device 400g may detect the first language without being provided with the first language from the terminal device 400f.

The translation server device 400g receives a request for the translation and processes, in operation 433, an operation which corresponds thereto (i.e., an operation of processing the translation). For example, a kind of language with respect to the original text (e.g., a first language) and a kind of language with respect to the translated text (e.g., a second language) are identified and original text of the first language is changed into translated text of the second language according to a translation algorithm. Further, the translation server device 400g provides the translated text to the terminal device 400f.

The original text and the translated text may be represented such that lengths of the original text and the translated text are different from each other due to linguistic characteristics. There may be a case in which the lengths of the original text and the translated text are required to be similarly adjusted as much as possible. The third system according to the embodiment of the present disclosure may be configured to allow the translation server device 400g to perform an operation of adjusting the lengths of the original text and the translated text. That is, the translation server device 400g identifies the lengths of the original text and the translated text in operation 434.

Even though it is illustrated that the lengths of the original text and the translated text are identified in operation 434 after the translation process is completed, the present disclosure is not limited thereto. For instance, the lengths of the original text and the translated text may be respectively identified in operation 431 and operation 433.

The translation server device 400g compares the length of the original text with the length of the translated text and identifies a difference between the length of the original text and the length of the translated text. When the difference between the length of the original text and the length of the translated text is large, an operation of reducing the length of the translated text is processed in order to reduce a difference between the length of the original text and the length of translated text. The operation of reducing the length of the translated text may be an operation of changing at least one first translation object included in the translated text into an alternative second translation object. For instance, the translation server device 400g changes, in operation 437, the at least one first translation object included in the translated text into a replaceable second translation object.

For example, the first translation object and the second translation object may be a word unit. The second object may be an alternative word having a meaning which is identical to the first translation word. Moreover, when the length of the translated text is relatively long in comparison with the length of the original text, the second translation object should include a relatively smaller number of characters than the first translated text. When the length of the translated text is relatively short in comparison with the length of the original text, the second translation object should include a relatively larger number of characters than the first translated text. Considering this, operation 435 may be configured so that the second translation object has a meaning which is identical to the first translation object and include an operation of identifying a word having a size which may reduce a difference between the length of the original text and the translated text. For example, the first translation object may be a full name of the word and the second translation object may include an abbreviation. On the contrary, the first object translation object may be an abbreviation of the word and the second translation object may include a full name.

For another example, the first translation object and the second translation object may be a phrase unit or a sentence unit which combine a plurality of words.

Furthermore, in an embodiment of the present disclosure, it is illustrated that the first translation object and the second translation object may be a word unit, a phase unit, a sentence unit, but the preset disclosure is not limited thereto. The preset disclosure requires only that the first translation object may be replaced with the second translation object having a meaning which is identical or similar to the first translation object and a length which may reduce the difference between the length of the original text and the length of the second translation.

As described above, after the at least one first translation object included in the translated text is changed into a replaceable second translation object, the translation server device 400g provides, in operation 436, the changed second translation object to the terminal device 400f and the terminal device 400f provides, in operation 437, translated text to which the second translation object is reflected.

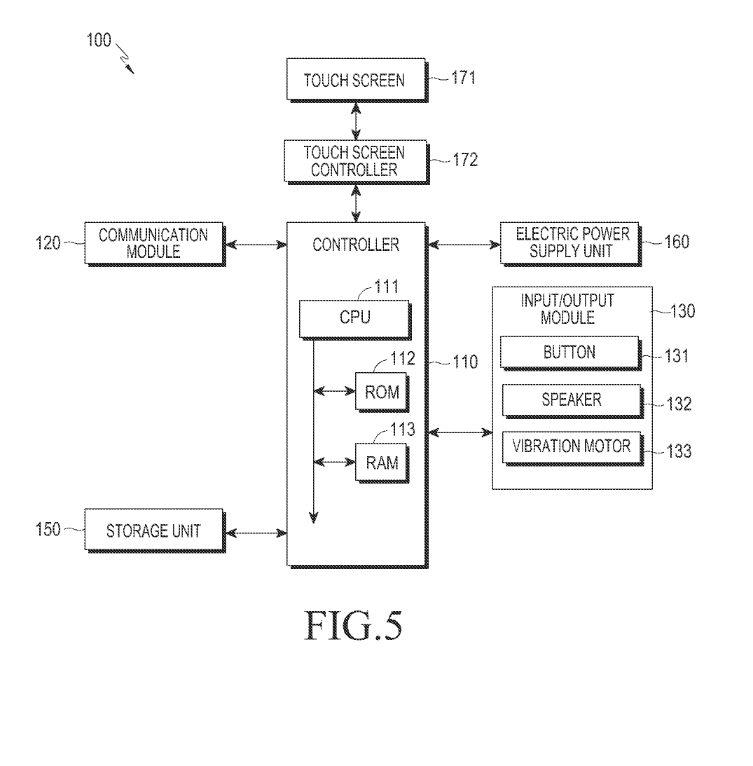

FIG. 5 is a block diagram of an apparatus applying a translation method according to various embodiments of the present disclosure.

Referring to FIG. 5, an apparatus 100 includes a controller 110, a communication module 120, an input/output module 130, a storage unit 150, an electric power supply unit 160, a touch screen 171, and a touch screen controller 172, but is not limited thereto.

The controller 110 may include a CPU 111, a ROM 112 in which a control program for a control of the apparatus 100 is stored, and a RAM 113 which stores signals or data input from outside of the apparatus 100, or is used as a storage region for operations performed by the apparatus 100. The CPU 111, the ROM 112, and the RAM 113 may be connected to one another through an internal bus. Further, the controller 110 may control the communication module 120, the input/output module 130, the storage unit 150, the power supplier 160, the touch screen 171, and the touch screen controller 172. Further, the controller 110 may be configured to be a single-core or a multiple core such as a dual-core, a triple-core, a quad-core, or the like. Of course, the number of the cores may be variously determined by a person having ordinary skill in the art according to characteristics of a terminal.

Especially, the controller 110 may process an operation of identifying original text, an operation of identifying translated text, and an operation of replacing at least one first translation object included in the translated text with a second translation object by comparing lengths of the original text and the translated text.

The communication module 120 may include at least one of a cellular module, a wireless LAN module, and a short-range communication module.

The cellular module allows the apparatus 100 to be connected to an external apparatus through a mobile communication unit using one or more antennas (not illustrated) under a control of the controller 110. The cellular module transmits/receives a wireless signal for voice communication, image communication, a Short Message Service (SMS) or a Multimedia Message Service (MMS) with a portable phone (not illustrated), a smart phone (not illustrated), a tablet PC or any other apparatus (not illustrated) that has a phone number input to the apparatus 100.

The wireless LAN module may be connected to the Internet at a place where a wireless Access Point (AP) (not shown) is installed, under the control of the controller 110. The wireless LAN module supports the wireless LAN provision (IEEE802.11x) of the Institute of American Electrical and Electronics Engineers (IEEE). The wireless LAN module may operate a Wi-Fi Positioning System (WPS) that identifies position information of a terminal which is provided with the wireless LAN module by using position information provided by a wireless Access Point (AP) wirelessly connected thereto.

The short-range communication module is a module which allows the apparatus 100 to perform short-range communication wirelessly with another apparatus under the control of the controller 110, and may process communication based on a short-range communication scheme such as Bluetooth communication, Infrared Data Association (IrDA) communication, Wi-Fi-Direct communication, and Near Field Communication (NFC).

Furthermore, the communication module 120 may perform data communication based on a communication scheme (e.g., USB communication, serial communication, or the like) with another electronic device connected through a USB communication cable, a serial communication cable, or the like.

The input/output module 130 may include at least one of a button 131, a speaker 132, and a vibration motor 133, but is not limited thereto.

The button 131 may be disposed on a front surface, a side surface or a rear surface of a housing of the apparatus 100, and may include at least one of an electric power supply/lock button (not shown), a volume button (not shown), a menu button, a home button, a back button, and a search button.

The speaker 132 may output sounds corresponding to various signals (e.g., a wireless signal, a broadcasting signal, and the like) of the cellular module, the wireless LAN module, and the short distance communication module to the outside of the apparatus 100 according to a control of the controller 110. The speaker 132 or a plurality of speakers 132 may be formed on a suitable position or positions of the housing of the apparatus 100.

The vibration motor 133 may convert an electronic signal to mechanical vibration under the control of the controller 110. One vibration motor 133 or a plurality of motors 133 may be formed within the housing of the apparatus 100.

The speaker 132 and the vibration motor 133 may be operated according to a set condition of a volume operation mode of the apparatus 100. For example, the volume operation mode of the apparatus 100 may be operated in a sound mode, a vibration mode, a sound and vibration mode, and a silent mode, and may be set to one of these modes. The controller 110 may output a signal that instructs the operation of the speaker 132 or the vibration motor 133 according to a function conducted by the apparatus 100, based on the mode to which the volume operation mode is set.

The storage unit 150 may store signals or data input/output corresponding to the operation of the input/output module 130 or the touch screen 171 under the control of the controller 110. The storage unit 150 may store a control program and an application for controlling the apparatus 100 or the controller 110.

The term, “storage unit” may include the storage unit 150, the ROM 112 and the RAM 113 in the controller 110, or a memory card (not shown), (e.g. an SD card or a memory stick), mounted in the apparatus 100. The storage unit may include a non-volatile memory, a volatile memory, a Hard Disc Drive (HDD) or a Solid State Drive (SSD).

The electric power supply unit 160 may supply electric power to one or more batteries (not shown) disposed in the housing of the apparatus 100 under the control of the controller 110. The one or more batteries (not shown) supply electric power to the apparatus 100. Further, the electric power supply unit 160 may supply the apparatus 100 with electric power input from an external electric power source (not shown) through a wired cable connected with a connector equipped to the apparatus 100. In addition, the electric power supply unit 160 may supply electric power wirelessly input from the external electric power source to the apparatus 100 through a wireless charging technology.

The touch screen 171 may display a user interface corresponding to various services (for example, a call, data transmission, and the like) to the user based on an Operation System (OS) of the terminal. The touch screen 171 may transmit an analog signal corresponding to at least one touch input to the user interface to the touch screen controller 172. The touch screen 171 may receive at least one touch caused by a body of the user, (e.g., fingers including a thumb), or a touchable input means (e.g., a stylus pen). Also, the touch screen 171 may receive a continuous movement of one touch among at least one touch. The touch screen 171 may transmit an analog signal corresponding to the continuous movement of the touch input thereto to the touch screen controller 172.

The touch screen 171 may be implemented in, for example, a resistive type, a capacitive type, an infrared type, or an acoustic wave type.

The touch screen controller 172 controls an output value of the touch screen 171 so that display data provided from the controller 110 may be displayed on the touch screen 171. On the other hand, the touch screen controller 172 converts analog signals received from the touch screen 171 into digital signals (e.g., X and Y coordinates), and transmits the digital signals to the controller 110.

The controller 110 may process a user input by using data provided from the touch screen 171 and the touch screen controller 172. The controller 110 may control the touch screen 171 by using the digital signal received from the touch screen controller 172. For example, the controller 110 allows a user to select or execute a shortcut icon (not shown) displayed on the touch screen 170 in response to the touch event or the hovering event.

In an embodiment of the present disclosure, it is illustrated that a user input receives an input through the touch screen 171, but the present disclosure is not limited thereto and the user input may be recognized and processed through various elements. For example, the apparatus according to the embodiment of the present disclosure may include a sensor module or a camera module and process the user input by using data input though the sensor module or the camera module.

For example, the sensor module may include at least one sensor among a proximity sensor detecting the accessibility to the apparatus 100 of the user, an illumination sensor detecting amount of light of circumjacent apparatus 100 and a Red, Green, Blue (RGB) sensor. In addition, a sensor module may include a motion sensor (not shown) detecting an operation (e.g., a rotation of the apparatus 100, an acceleration or vibration applied to the apparatus 100) of the apparatus 100. Furthermore, information detected from the sensor module may be provided to the controller 110 and the controller 110 may process the user input by using the detected information.

The camera module is located in a front or rear of the apparatus and may include a camera photographing a still image or video under the control of the controller 110. The still image or video photographed by the camera may be provided to the controller 110. The controller 110 may process the user input by using a still image or video provided in the camera.

Moreover, methods according to various embodiments of the present disclosure as described above may be implemented with a program command type which may be performed through diverse computer means and recorded in a computer readable medium. The computer readable medium may include a program command, a data file, a data structure, and the like independently or in combination. The program instruction recorded in the computer-readable medium may be one which is specifically designed and configured for the present disclosure, or may be well-known to and used by a person ordinarily skilled in the art of computer software.

Also, the methods according to the various embodiments of the present disclosure may be implemented in a program instruction form and stored in the storage unit 150 of the above-described apparatus 100, and the program instruction may be temporarily stored in the RAM 113 included in the controller 110 so as to execute the methods according to the various embodiments of the present disclosure. As a result, the controller 110 may perform the control of hardware components included in the apparatus 100 in response to the program commands according to the methods of the various embodiments of the present disclosure, temporarily or continuously store the data produced while executing the methods according to the various embodiments in the storage unit 150, and provide UIs required for executing the methods according to the various embodiments of the present disclosure to the touch screen controller 172.

It will be appreciated that the various embodiments of the present disclosure may be implemented in a form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, which are machine (computer) readable storage media, regardless of its ability to be erased or its ability to be re-recorded. It may be also appreciated that the memory included in the mobile terminal is one example of machine-readable devices suitable for storing a program including instructions that are executed by a processor device to thereby implement embodiments of the present disclosure. Accordingly, the present disclosure includes a program for a code implementing the apparatus and method described in the appended claims of the specification and a machine (a computer or the like)-readable storage medium for storing the program. Further, the program may be electronically transferred by any communication signal through a wired or wireless connection, and the present disclosure appropriately includes equivalents of the program.

Further, the computer or the electronic device may receive and store the program from a program providing device wiredly or wirelessly connected thereto. The program providing apparatus may include a program with instructions to perform the previously configured contents protecting method, a memory for storing information necessary for the contents protecting method, a communication unit for performing a wired or wireless communication, and a controller for controlling a transmission of the program. When a request for providing the program has been received from the computer or the electronic device, the program providing device may wiredly or wirelessly provide the program to the computer or the electronic device. Further, when the request for providing the program has been not received from the computer or the electronic device (e.g., the computer or the electronic device is located in a specific place), the program providing device may be configured to wiredly or wirelessly provide the program to the computer or the electronic device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A translation method comprising:
identifying original text and translated text in which the original text is translated; and
replacing at least one first translation object included in the translated text with a second translation object by comparing a length of the original text and and a length of the translated text.

2. The method of claim 1, wherein the second translation object comprises an object having a meaning which is similar to the at least one first translation object.

3. The method of claim 1, wherein the second translation object comprises an object having a length which is longer in comparison with the at least one first translation object.

4. The method of claim 1, wherein the second translation object comprises an object having a length which is shorter in comparison with the at least one first translation object.

5. The method of claim 1, wherein each of the at least one first translation object and the second translation object is a word unit.

6. The method of claim 1, wherein each of the at least one first translation object and the second translation object is a sentence unit.

7. The method of claim 1, wherein the identifying of the original text and the translated text comprises:
identifying the length of the original text; and
identifying the length of the translated text.

8. The method of claim 1, wherein the replacing of the at least one first translation object with the second translation object comprises:
identifying a standard length configured based on the original text and the length of the translated text;
identifying a replaceable first translation object when the length of the translated text is greater than a range of the standard length; and
replacing the identified first translation object with the second translation object.

9. The method of claim 8, wherein the standard length comprises at least one among the length of the original text, a maximum length acceptable in a line unit of the original text and a minimum length acceptable in a line unit of the original text.

10. The method of claim 1, wherein the replacing of the at least one first translation object with the second translation object comprises:
identifying the replaceable at least one first translation object;
identifying at least one candidate second translation object having a meaning similar to the at least one first translation object and having a length which is different from the length of the at least one first translation object; and
identifying the second translation object to be replaced among the candidate second translation objects.

11. The method of claim 10, wherein the determining of the second translation object comprises detecting the second translation object which has a meaning mostly similar to the at least one first translation object and reduces a difference between a configured standard length and the length of the translated text based on the original text, among the at least one candidate second translation object.

12. The method of claim 1, wherein the second translation object has a meaning similar to the at least one first translation object and a length different from the length of the at least one first translation object.

13. An apparatus for providing a translation process comprising:
a memory unit that stores a translation program and data generated while processing the translation program; and
at least one controller,
wherein the translation process program is configured to be executed by the controller, and includes a command that identifies original text and translated text in which the original text is translated and replaces at least one first translation object included in the translated text with a second translation object by comparing a length of the original text and a length of the translated text.

14. The apparatus of claim 13, wherein the translation process program comprises a command that transmits the original text to a translation server device providing the translation process and receives the translated text from the translation server device.

15. The apparatus of claim 14, wherein the translation process program comprises a command that replaces the at least one first translation object included in the translated text with the second translation object by comparing the length of the original text and the length of the translated text.

16. The apparatus of claim 14, wherein the translation process program comprises a command that processes an operation of transmitting the command that replaces the at least one first translation object included in the translated text with the second translation object by comparing the length of the original text and the length of the translated text to the translation server device and receiving the translated text in which the at least one first translation object is replaced with the second translation object from the translation server device.

17. The apparatus of claim 13, wherein the translation process program comprises a command that processes an operation of transmitting the original text to the translation server device providing the translation process and receiving the translated text in which the at least one first translation object included in the translated text is replaced with the second translation object by comparing the length of the original text and the length of the translated text from the translation server device.

18. The apparatus of claim 13, wherein the translation process program comprises a command that processes an operation of comparing a configured standard length and the length of the translated text based on the original text, identifying a replaceable at least one first translation object when a difference between the standard length and the length of the translated text is greater than an error range and replacing the identified at least one first translation object with the second translation object.

19. The apparatus of claim 18, wherein the standard length comprises at least one among the length of the original text, a maximum length acceptable in a line unit of the original text and a minimum length acceptable in a line unit of the original text.

20. The apparatus of claim 13, wherein the second translation object comprises a meaning similar to the at least one first translation object and a length different from the length of the at least one first translation object.

21. The apparatus of claim 13, wherein the controller executes the translation process program in response to a translation menu selection among a plurality of menu selections.
